(19) United States
(12) Patent Application Publication
(10) Pub. No.: US 2026/0250792 A1
(43) Pub. Date: Aug. 27, 2026

(54) EXOTHERMIC IRON COMPOUNDS FOR PRODUCING IRON OXIDE PELLETS

(71) Applicant: IRON ORE COMPANY OF CANADA, Montréal (CA)

(72) Inventors: Blair KELLY, Labrador City (CA); Karim SELIM, Labrador City (CA); Jim THOMPSON, Senneville (CA)

(21) Appl. No.: 18/872,541

(22) PCT Filed: Jul. 19, 2024
(86) PCT No.: PCT/CA2024/050958

§ 371 Date: Dec. 6, 2024

Related U.S. Application Data
(60) Provisional application No. 63/514,923, filed on Jul. 21, 2023.

(51) Int. Cl. C21B 13/00; C01G 49/02; C22B 1/24; C22B 1/243; C22B 1/244

(52) U.S. Cl. CPC C21B 13/0046; C01G 49/02; C22B 1/2406; C22B 1/2413; C22B 1/243; C22B 1/244

(57) ABSTRACT

There is provided a method of producing iron oxide pellets having a target internal energy measured as a target heat of magnetite equivalent (HME). An iron oxide is reduced into an exothermic iron compound having a lower oxidation number. The exothermic iron compound is magnetite, wustite, and/or metallic iron and is mixed with iron ore, a binder and optionally a carbon material selected from coke breeze, anthracite and biomass. The iron ore comprises magnetite and/or hematite and/or goethite. The mixture contains at least 1 wt. % of the exothermic iron compound and from 0 to 0.8 wt. % of total carbon. The mixture contains a sufficient amount of magnetite, wustite, and/or metallic iron to maintain the target HME calculated as follows:

$$target HME = \frac{CV of CM}{CV of mag} ( wt . \% of CM ) + wt . \% of mag + \frac{CV of wus}{CV of mag} ( wt . \% of wus ) + \frac{CV of {Fe}_{metal}}{CV of mag} ( wt . \% of {Fe}_{metal} )$$

where CM stands for carbon material, CV stands for calorific value, wus is
wustite, mag is magnetite, and Feₘₑₜₐₗ is metallic iron;

The iron pellets are formed from the mixture, dried and subjected to an induration process.

### CROSS-REFERENCE TO A RELATED APPLICATION

This disclosure claims priority from U.S. Provisional Application No. 63/514,923 filed Jul. 21, 2023, which is incorporated herein by reference in its entirety.

### TECHNICAL FIELD

This disclosure relates to the field of iron oxide pellets and methods of making same.

### BACKGROUND OF THE ART

Iron oxide pellets (or pellets), referred to as greenballs before they are dried and indurated, are produced in a generally spherical form (5-20 mm of diameter) by rolling finely ground iron ore with suitable additives and a binder. Pellets are utilized as feedstock for direct reduction (DR) or blast furnace (BF) iron making operations. To obtain sufficient internal energy to facilitate the induration of a greenball into a pellet of acceptable quality, coke breeze is traditionally included in the greenball mix. The inclusion of coke breeze leads to a significant production of carbon dioxide during the formation of the pellet, particularly at the induration step. Accordingly, improvements in the pelletizing process are desired, particularly a reduction in the production of carbon dioxide while maintaining sufficient internal energy in the iron oxide pellets.

### SUMMARY

In one aspect, there is provided a method of producing iron oxide pellets having a target internal energy measured as a target heat of magnetite equivalent (HME), the method comprising:
reducing an iron oxide into an exothermic iron compound having a lower oxidation number, wherein the exothermic iron compound is magnetite, wustite, and/or metallic iron;
mixing the exothermic iron compound, with iron ore, a binder and a carbon material selected from coke breeze, anthracite, and biomass, wherein the iron ore comprises magnetite and hematite, wherein the exothermic iron compound is present in a concentration of at least 1 wt. %, wherein a total carbon concentration in the mixture is in the range of from 0 to 0.8 wt. %, and wherein the mixture contains a sufficient amount of magnetite, wustite, and/or metallic iron to maintain the target HME calculated as follows:

$$target HME = \frac{CV of CM}{CV of mag} ( wt . \% of CM ) + wt . \% of mag + \frac{CV of wus}{CV of mag} ( wt . \% of wus ) + \frac{CV of {Fe}_{metal}}{CV of mag} ( wt . \% of {Fe}_{metal} )$$

wherein CM stands for carbon material, CV stands for calorific value, wus is wustite, mag is magnetite, and Feₘₑₜₐₗ is metallic iron;
forming iron pellets from the mixture;
drying the iron pellets; and
subjecting the iron pellets to an induration process.

In some embodiments, the iron oxide is hematite. In some embodiments, the step of reducing is a hydrogen reduction. In some embodiments, the hydrogen reduction is supplied energy from hydroelectric energy. In some embodiments, the step of reducing is performed in a green hydrogen based fluidized bed reduction reactor.

In some embodiments, the concentration of the total carbon is less than 0.1 wt. %.

In some embodiments, the carbon material is coke breeze, preferably the concentration of the coke breeze in the mixture is less than 0.1 wt. %.

In some embodiments, the mixing comprises grinding and/or ball milling.

In some embodiments, the method further comprises, after the mixing and before the forming, breaking lumps in the mixture.

In some embodiments, the method further comprises, before the forming, filtering the mixture to exclude particles larger than 200 μm.

In some embodiments, the binder is bentonite and/or an organic binder.

In some embodiments, the mixture further comprises an additive selected from limestone and dolomite.

In some embodiments, the concentration of the magnetite in the mixture is from 10 to 80 wt. % or is from 35 to 45 wt. %.

In some embodiments, the mixture is in the form of a slurry.

In some embodiments, the exothermic iron compound is provided in powder form.

There is also provided an iron oxide pellet obtained or obtainable from the method of the present disclosure.

Many further features and combinations thereof concerning the present improvements will appear to those skilled in the art following a reading of the instant disclosure.

### DETAILED DESCRIPTION

The present disclosure provides the use of exothermic iron compounds as a substitute for carbon materials (i.e. coke breeze, anthracite and/or biomass) in the production of iron oxide pellets. The term “biomass” as used herein refers to the charcoal-like material obtained by burning organic matter such as biowaste from the agriculture or forestry industries. In some embodiments, the term biomass can be defined as consisting of carbon and ashes. The term “coke breeze”, in some embodiments, refers to the residue obtained from the screening of heat treated coke, and has a size of less than one-half inch. The addition of exothermic iron compounds allows to reduce or eliminate the concentration of carbon materials in iron oxide pellets and to reduce the resulting CO₂ emissions while maintaining a target internal energy of the iron oxide pellets. Depending on the pellets' chemical and mineralogical composition, the target internal energy will vary.

Iron oxide pellets are produced by mixing iron ore with a binder and optionally additives. Traditionally, after selecting the target internal energy, an amount of carbon material such as coke breeze is added in the mixture to have the resulting iron oxide pellets reach the target internal energy. However, this addition of carbon material (e.g. coke breeze) leads to undesirable CO₂ emissions during the pelletizing process. To reduce or eliminate the carbon content, exothermic iron compounds which include magnetite, wustite, and/or metallic iron are provided instead of the carbon material and preferably completely replace the carbon material addition. The term “exothermic iron compounds” is defined herein to mean magnetite, wustite, and/or metallic iron. In some embodiments, the exothermic iron compounds are provided in powder form. The powder may have a particle size of less than 2 mm. The particle size can be measured by image analysis (e.g. microscopy, laser diffraction, dynamic light scattering) or other suitable means.

Traditionally, coke breeze is included in the mixture to produce pellets in a concentration of 1.1 to 1.6 wt. % (e.g. about 1.4 wt. %). The use of the exothermic iron compounds allows for the reduction of coke breeze concentration or other carbon materials to up to 0.8 wt. %, up to 0.7 wt. %, up to 0.6 wt. %, up to 0.5 wt. %, up to 0.4 wt. %, up to 0.3 wt. %, up to 0.2 wt. % or to less than 0.1 wt. %. In some embodiments, no coke breeze is added in the mixture and therefore the exothermic iron compounds completely replace the coke breeze. More generally when considering carbon materials, reference can be made to the carbon concentration rather than the coke breeze concentration. Accordingly, the concentration of elemental carbon in the mixture is up to up to 0.8 wt. %, up to 0.7 wt. %, up to 0.6 wt. %, up to 0.5 wt. %, up to 0.4 wt. %, up to 0.3 wt. %, up to 0.2 wt. % or to less than 0.1 wt. %. To achieve the reduction in carbon content, the exothermic iron compounds are included in the mixture in a concentration of at least 1 wt. %, at least 1.5 wt. %, at least 2 wt. %, from 1 to 12 wt. %, from 2 to 10 wt. %, or from 3 to 8 wt. %.

The iron ore as used herein contains hematite and magnetite and can contain goethite. The target internal energy for the iron oxide pellets is calculated as a target heat of magnetite equivalent (HME). The equation is as follows:

$$target HME = \frac{CV of CM}{CV of mag} ( wt . \% of CM ) + wt . \% of mag + \frac{CV of wus}{CV of mag} ( wt . \% of wus ) + \frac{CV of {Fe}_{metal}}{CV of mag} ( wt . \% of {Fe}_{metal} )$$

Where CM=carbon material, CV=calorific value, wus=wustite and mag=magnetite, or alternatively

$$target HME = \frac{CV of coke}{CV of mag} ( wt . \% of coke ) + wt . \% of mag + \frac{CV of wus}{CV of mag} ( wt . \% of wus ) + \frac{CV of {Fe}_{metal}}{CV of mag} ( wt . \% of {Fe}_{metal} )$$

The equation is such that when the wt. % of carbon material or coke breeze is 0, the concentration of the exothermic iron compounds is increased to maintain the target HME at the same value or in some cases the HME can be increased. The concentration of magnetite is in the range of from 10 to 80 wt. % to obtain a useful iron oxide pellet, and in some cases in the range of 30 to 50 wt. % or 35 to 45 wt. %. The calorific values of coke breeze, magnetite, wustite, and metallic iron are measurable values that may not necessarily be constant. They can be measured with a calorimeter. In some embodiments, the calorific value of magnetite is from 490 MJ/kg to 520 MJ/kg or about 495 MJ/kg. In some embodiments, the calorific value of wustite is from 2040 to 2060 MJ/kg or about 2051 MJ/kg, and the caloric value of metallic iron is from 7350 to 7370 kJ/kg or about 7360 kJ/kg.

The exothermic iron compounds are obtained by performing a reduction on an iron oxide to reduce the oxidation number of that iron oxide. The iron oxide that is reduced to obtain the exothermic iron compounds is preferably hematite. The reduction reaction can for example be a hydrogen reduction. In one embodiment, the reduction is performed on a green hydrogen based fluidized bed reduction reactor. The advantage of producing the exothermic iron compounds is that the oxidation level and other physico-chemical properties of the obtained exothermic iron compounds can be controlled in order to a target internal energy in order to replace coke breeze in the iron oxide pellet production process. It is preferred to produce the exothermic iron compounds on site because reduced iron is not completely stable and will revert back to its oxidized form. Accordingly, in some embodiments, there is a minimal delay between the time the exothermic iron compound is produced and when the exothermic iron compound is mixed with the iron ore and the binder to produce the iron oxide pellets. This minimal delay can be defined as same day, less than 5 h, less than 2 h or less than 1 h. An important advantage of using a hydrogen reduction as opposed to reductions fueled by hydrocarbons is the absence of carbon dioxide emissions. The hydrogen reduction can preferably be fueled by green energy for example hydroelectric energy, wind turbine energy and the like. This allows the internal energy process of iron oxide pellet making to be free of carbon dioxide emissions and can be generally considered carbon free. In some embodiments, an advantage of hydrogen reduction is that it allows to supply hydrogen to different areas.

In the process of making iron oxide pellets, the mixture is kept as a slurry and dewatered before the agglomeration step where a binder is added. Examples of binders that can be included in the dewatered mixture are bentonite and/or organic binders (that are substitutes to bentonite). These organic binders include a variety of carbon-based polymeric or fibrous compounds. Limestone and/or dolomite are optional additives that can be included in the mixture and additives that can be processed by grinding and/or ball milling, for example wet ball milling. Optionally, after the grinding and/or ball milling, the mixture can be treated so as to break the lumps formed (if any). Filtration is used to remove the water from the slurry mixture.

The pellets are formed by shaping into spherical shapes (i.e. the material is agglomerated into green balls). Preferably, the mixture is first filtered to exclude particles larger than 200 μm. The balls formed are then conveyed to be subjected to the induration process. Induration is a process of drying and firing (cooking), and cooling the pellets. The induration process can be subdivided into steps of evaporation, calcination, combustion, fusion, and oxidation of the various compounds with the objective of achieving target physical and metallurgical properties. The final product is fired pellets, and the off gases during the induration process are exhausted through a stack on each induration machine.

The use of coke breeze is the largest emitter of CO₂ equivalent at the Iron Ore Company (IOC) of Canada. The coke breeze is used as an internal energy source in iron ore pelletizing which contributes to enhancing product quality and reducing fuel consumption (i.e. heavy fuel oil) which completes the iron ore induration process. Iron ore pellets require thermal energy to complete all the necessary drying, calcination, combustion, fusion, and sintering reactions. The present disclosure replaces at least a portion of the coke breeze with an exothermic iron compound in order to reduce the CO₂ emissions while maintaining similar properties for the pellets. The exothermic iron compound (i.e. magnetite, wustite, and/or metallic iron) provides the thermal energy required while reducing or avoiding CO₂ emissions without diluting the iron content of the iron ore pellets.

1. A method of producing iron oxide pellets having a target internal energy measured as a target heat of magnetite equivalent (HME), the method comprising:
reducing an iron oxide into an exothermic iron compound having a lower oxidation number, wherein the exothermic iron compound is magnetite, wustite, and/or metallic iron;
mixing the exothermic iron compound, with iron ore, a binder and a carbon material selected from coke breeze, anthracite, and biomass, wherein the iron ore comprises magnetite and hematite, wherein the exothermic iron compound is present in a concentration of at least 1 wt. %, wherein a total carbon concentration in the mixture is in the range of from 0 to 0.8 wt. %, and wherein the mixture contains a sufficient amount of magnetite, wustite, and/or metallic iron to maintain the target HME calculated as follows:
$$target HME = \frac{CV of CM}{CV of mag} ( wt . \% of CM ) + wt . \% of mag + \frac{CV of wus}{CV of mag} ( wt . \% of wus ) + \frac{CV of {Fe}_{metal}}{CV of mag} ( wt . \% of {Fe}_{metal} ) .$$
Wherein CM stands for carbon material, CV stands for calorific value, wus is wustite, mag is magnetite, and Feₘₑₜₐₗ is metallic iron;
forming iron pellets from the mixture;
drying the iron pellets; and
subjecting the iron pellets to an induration process.

2. The method of claim 1, wherein the iron oxide is hematite.

3. The method of claim 1, wherein the step of reducing is a hydrogen reduction.

4. The method of claim 3, wherein the hydrogen reduction is supplied energy from hydroelectric energy.

5. The method of claim 3, wherein the step of reducing is performed in a green hydrogen based fluidized bed reduction reactor.

6. The method of claim 1, wherein the concentration of the total carbon is less than 0.1 wt. %.

7. The method of claim 1, wherein the carbon material is coke breeze.

8. The method claim 6, wherein the concentration of the coke breeze in the mixture is less than 0.1 wt. %.

9. The method of claim 1, wherein the mixing comprises grinding and/or ball milling.

10. The method of claim 1, further comprising, after the mixing and before the forming, breaking lumps in the mixture.

11. The method of claim 1, further comprising, before the forming, filtering the mixture to exclude particles larger than 200 μm.

12. The method of claim 1, wherein the binder is bentonite and/or an organic binder.

13. The method of claim 1, wherein the mixture further comprises an additive selected from limestone and dolomite.

14. The method of claim 1, wherein the concentration of the magnetite in the mixture is from 10 to 80 wt. %.

15. The method of claim 1, wherein the concentration of the magnetite is from 35 to 45 wt. %.

16. The method of claim 1, wherein the mixture is in the form of a slurry.

17. The method of claim 1, wherein the exothermic iron compound is provided in powder form.

18. An iron oxide pellet produced by the method of claim.
